(19) United States
(12) Patent Application Publication
(10) Pub. No.: US 2026/0067800 A1
(43) Pub. Date: Mar. 5, 2026

(54) METHOD AND APPARATUS FOR MANAGING ENERGY INFORMATION IN WIRELESS COMMUNICATION SYSTEM

(71) Applicant: LG UPLUS CORP., Seoul (KR)

(72) Inventor: Won Jung KIM, Seoul (KR)

(21) Appl. No.: 19/382,113

(22) Filed: Nov. 6, 2025

Related U.S. Application Data
(63) Continuation of application No. PCT/KR2024/095827, filed on May 17, 2024.

(30) Foreign Application Priority Data
Jun. 26, 2023 (KR) 10-2023-0081748

(51) Int. Cl. H04W 52/02; H04W 48/16

(52) U.S. Cl. CPC H04W 52/0203; H04W 48/16

(57) ABSTRACT

The present specification proposes a method and an apparatus for managing energy information in a next-generation wireless communication system. A next-generation wireless communication system including a 5G system may have defined therein an energy information repository function (EIRP) having a new network function capable of: exposing energy information to an AF; collecting information regarding energy of the AF; and storing and managing the energy information. The EIRF may provide energy information of a UE to the AF of a third party, and the AF may acquire energy information from the 5G system and monitor the acquired energy information. In addition, the AF may perform a system configuration based on energy efficiency, such as charging or restricting a service according to the energy information. Also, by the function, the AF may adjust service provision such as video playback by checking energy source information or carbon emission information.

### RELATED AND PRIORITY APPLICATIONS

This application is a continuation of PCT/KR2024/095827 filed on May 17, 2024, which claims priority to Korean Patent App. No. 10-2023-0081748, each of which is incorporated by reference herein in its entirety.

### TECHNICAL FIELD

The present disclosure relates to wireless communication, and more particularly, to a method and an apparatus for managing energy information in a wireless communication system.

### BACKGROUND

3rd Generation Partnership Project (3GPP) Long-Term Evolution (LTE) is a technology designed to enable high-speed packet communication. To achieve the LTE objectives of reducing costs for users and operators, improving quality of service, expanding coverage, and increasing system capacity, various techniques have been proposed. As high-level requirements, 3GPP LTE demands reduced cost per bit, improved service usability, flexible use of frequency bands, a simplified architecture, open interfaces, and appropriate power consumption of user equipments (UEs).

The International Telecommunication Union (ITU) and 3GPP have initiated the development of requirements and specifications for a New Radio (NR) system. 3GPP needs to identify and develop the technical components necessary to successfully standardize NR to meet, in a timely manner, both urgent market demands and longer-term requirements presented by the ITU Radiocommunication Sector (ITU-R) International Mobile Telecommunications (IMT)-2020 process. Furthermore, NR should be capable of using any spectrum band extending up to at least 100 GHz, which can be used for wireless communication in the distant future.

NR targets a single technical framework that covers all deployment scenarios, use cases, and requirements, including enhanced Mobile Broadband (eMBB), massive Machine Type Communications (mMTC), and Ultra-Reliable and Low Latency Communications (URLLC). NR is required to inherently possess forward compatibility.

### DISCLOSURE

### Technical Problem

The present disclosure proposes a method and an apparatus for managing energy information in a wireless communication system.

### Technical Solution

In an aspect of the present disclosure, provided herein is a method performed by a first network function for energy-related information operating in a wireless communication system. The method includes: receiving energy-related information from a second network function including at least one of a Network Exposure Function (NEF), a Policy Control Function (PCF), a Unified Data Management (UDM), an Access and Mobility Management Function (AMF), a Session Management Function (SMF), or a User Plane Function (UPF); storing the energy-related information; and providing the energy-related information to the second network function.

The energy-related information may include energy information provided by an Application Function (AF) to the wireless communication system.

The energy information may include at least one of information on an energy source, information on power consumption, and information on carbon emissions, and the energy source may include at least one of renewable energy and thermal energy.

The energy-related information may include energy information provided by a network to an AF.

The energy information may include at least one of information on an energy source, energy information of a User Equipment (UE), energy information of a UPF in use, information on power consumption, and information on carbon emissions.

The second network function may further include a third-party AF.

In another aspect of the present disclosure, provided herein is an apparatus configured to implement a first network function for energy-related information operating in a wireless communication system. The apparatus includes a memory and a processor operably connected to the memory. The processor is configured to receive energy-related information from a second network function including at least one of an NEF, a PCF, a UDM, an AMF, an SMF, and a UPF; store the energy-related information; and provide the energy-related information to the second network function. The first network function is configured to provide a service related to at least one of storage and management of the energy-related information.

The energy-related information may include energy information provided by an AF to the wireless communication system.

The energy information may include at least one of information on an energy source, information on power consumption, and information on carbon emissions, and the energy source may include at least one of renewable energy and thermal energy.

The energy-related information may include energy information provided by a network to an AF.

The energy information may include at least one of information on an energy source, energy information of a UE, energy information of a UPF in use, information on power consumption, and information on carbon emissions.

The second network function may further include a third-party AF.

In a further aspect of the present disclosure, provided herein is an apparatus including at least one computer-readable medium including instructions based on execution by at least one processor. The instructions, when executed, cause the at least one processor to store energy-related information, provide the energy-related information to another network function, and provide a service related to at least one of storage and management of the energy-related information.

The apparatus may receive the energy-related information from another network function.

The energy-related information may include energy information provided by an AF to the wireless communication system.

The energy information may include at least one of information on an energy source, information on power consumption, and information on carbon emissions, and the energy source may include at least one of renewable energy and thermal energy.

The energy-related information may include energy information provided by a network to an AF.

The energy information may include at least one of information on an energy source, energy information of a UE, energy information of a UPF in use, information on power consumption, and information on carbon emissions.

### Advantageous Effects

According to the present disclosure, an Energy Information Repository Function (EIRF) having a new network function capable of exposing energy information to an Application Function (AF), collecting energy-related information of the AF, and storing and managing energy information may be defined in a next-generation wireless communication system including a 5G system. The EIRF may provide energy information of a UE to a third-party AF, and the AF may acquire and monitor energy information in the 5G system. In addition, the AF may perform a system configuration operation based on energy efficiency, such as charging or restricting services according to the energy information. Furthermore, through the above function, the AF may adjust service provision, such as video playback, based on energy source information or carbon emission information. Accordingly, the energy efficiency of the wireless communication system may be improved.

The effects obtainable from specific examples of the present disclosure are not limited to those described above. For example, there may exist various technical effects that a person having ordinary skill in the related art can understand or derive from the present disclosure. Accordingly, the effects of the present disclosure are not limited to those explicitly described herein, but may include various effects that can be understood or derived from the technical features of the present disclosure.

### BRIEF DESCRIPTION OF THE DRAWINGS

The following drawings are provided to illustrate specific examples of the present disclosure. The names of specific devices, or the names of particular signals, messages, or fields shown in the drawings, are presented merely as examples, and therefore, the technical features of the present disclosure are not limited to the specific names used in the drawings below.

FIG. 1 illustrates an example of a communication system to which an implementation of the present disclosure is applied.

FIG. 2 illustrates an example of a wireless device to which an implementation of the present disclosure is applied.

FIG. 3 illustrates an example of a wireless device to which an implementation of the present disclosure is applied.

FIG. 4 illustrates an example of a User Equipment (UE) to which an implementation of the present disclosure is applied.

FIG. 5 illustrates an example of a 5G system architecture to which an implementation of the present disclosure is applied.

FIG. 6 illustrates an example of a 5G system architecture in which an Energy Information Repository Function (EIRF) is added.

FIG. 7 illustrates another example of a 5G system architecture in which an EIRF is added.

FIG. 8 is a flowchart illustrating operations of a network function according to some implementations of the present disclosure.

### DETAILED DESCRIPTION

The present disclosure may be modified in various ways and may have several embodiments, and specific embodiments are illustrated in the drawings and described in detail in the detailed description. However, the present disclosure is not intended to be limited to the specific embodiments, and it should be understood that the present disclosure includes all modifications, equivalents, and alternatives falling within the spirit and scope of the present disclosure. In the description of each drawing, like reference numerals are used to denote like components.

In the present disclosure, terms such as “first,” “second,” “A,” and “B” may be used to describe various elements, but such elements should not be limited by these terms. These terms are used only for the purpose of distinguishing one element from another. For example, without departing from the scope of the present disclosure, a first element may be referred to as a second element, and similarly, a second element may be referred to as a first element. In addition, the term “and/or” encompasses any combination of a plurality of associated listed items, or any one of the plurality of associated listed items.

When an element is described as being “connected to” or “coupled to” another element in the present disclosure, it should be understood that the element may be directly connected or coupled to the other element, or that an intervening element may be present therebetween. In contrast, when an element is described as being “directly connected to” or “directly coupled to” another element, it should be understood that no intervening element exists between the elements.

The terminology used in the present disclosure is intended only to describe particular embodiments and is not intended to limit the scope of the present disclosure. Unless the context clearly indicates otherwise, the singular forms are intended to include the plural forms as well. In the present disclosure, terms such as “include” and “have” are intended to specify that certain features, numbers, steps, operations, elements, parts, or combinations thereof are present, but should be understood not to preclude the presence or addition of one or more other features, numbers, steps, operations, elements, parts, or combinations thereof.

Unless otherwise defined, the terms used in the present disclosure, including technical and scientific terms, have the same meanings as commonly understood by those skilled in the art to which the present disclosure pertains. Terms that are defined in commonly used dictionaries should be interpreted as having meanings consistent with the contextual meaning within the relevant technical field, and unless explicitly defined in the present disclosure, the terms should not be interpreted in an idealized or overly formal sense.

Before describing the drawings in detail, it should be clearly understood that the classification of components in the present disclosure is merely based on the primary functions performed by each component. That is, two or more components to be described below may be combined into a single component, or a single component may be divided into two or more components according to more detailed functions.

Furthermore, each component described below may perform, in addition to the primary function thereof, some or all of the functions performed by other components, and a part of the primary function of each component may be exclusively performed by another component. Accordingly, the presence of each component described in the present disclosure should be construed functionally.

In the present disclosure, “A or B” may mean “only A,” “only B,” or “both A and B.” In other words, in the present disclosure, “A or B” may be interpreted as “A and/or B.” For example, in the present disclosure, “A, B or C” may mean “only A,” “only B,” “only C,” or any combination of A, B, and C.

In the present disclosure, a slash (/) or a comma (,) may represent “and/or.” For example, “A/B” may mean “A and/or B.” Accordingly, “A/B” may mean “only A,” “only B,” or “both A and B.” For example, “A, B, C” may mean “A, B, or C.”

In the present disclosure, the expression “at least one of A and B” may mean “only A,” “only B,” or “both A and B.” In addition, the expressions “at least one of A or B” and “at least one of A and/or B” may be interpreted in the same manner as “at least one of A and B.”

In the present disclosure, the expression “at least one of A, B and C” may mean “only A,” “only B,” “only C,” or any combination of A, B, and C. In addition, the expressions “at least one of A, B or C” and “at least one of A, B and/or C” may have the same meaning as “at least one of A, B and C.”

Hereinafter, preferred embodiments of the present disclosure will be described in detail with reference to the accompanying drawings.

In the following, a communication system applicable to the present disclosure will be described.

Without being limited thereto, various descriptions, functions, procedures, proposals, methods, and/or operational sequences of the present disclosure described herein may be applicable to various fields that require wireless communications/connections (e.g., 5G) between devices.

More specific examples will be described with reference to the drawings. In the following drawings and descriptions, the same reference numerals may represent identical or corresponding hardware blocks, software blocks, or functional blocks, unless otherwise described.

The following techniques, devices, and systems may be applicable to various wireless multiple access systems. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi-Carrier Frequency Division Multiple Access (MC-FDMA) system. CDMA may be implemented through wireless technologies such as Universal Terrestrial Radio Access (UTRA) or CDMA2000. TDMA may be implemented through wireless technologies such as Global System for Mobile Communications (GSM), General Packet Radio Service (GPRS), or Enhanced Data rates for GSM Evolution (EDGE). OFDMA may be implemented through wireless technologies such as Institute of Electrical and Electronics Engineers (IEEE) 802.11 (Wi-Fi), IEEE 802.16 (WiMAX), IEEE 802.20, or Evolved Universal Terrestrial Radio Access (E-UTRA). UTRA is a part of the Universal Mobile Telecommunications System (UMTS). 3rd Generation Partnership Project (3GPP) Long-Term Evolution (LTE) is a part of the Evolved UMTS (E-UMTS) that utilizes E-UTRA. 3GPP LTE employs OFDMA in downlink (DL) and SC-FDMA in uplink (UL). The evolution of 3GPP LTE includes LTE-Advanced (LTE-A), LTE-A Pro, and/or 5G New Radio (NR).

For convenience of explanation, the embodiments of the present disclosure are mainly described in connection with a 3GPP-based wireless communication system. However, the technical features of the present disclosure are not limited thereto. For example, although the following detailed description is provided based on a mobile communication system corresponding to the 3GPP-based wireless communication system, the aspects of the present disclosure that are not limited to the 3GPP-based wireless communication system may also be applied to other mobile communication systems.

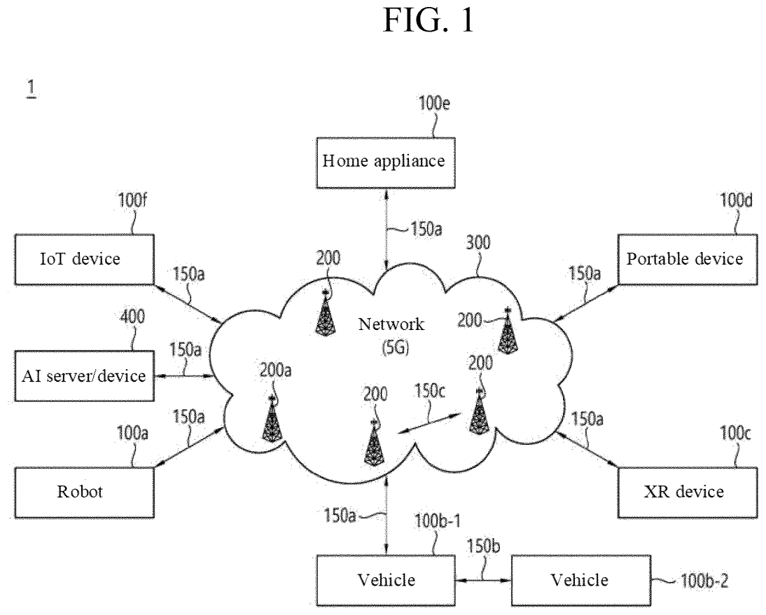

FIG. 1 illustrates an example of a communication system to which an implementation of the present disclosure is applied.

The 5G use scenario shown in FIG. 1 is merely an example, and the technical features of the present disclosure may be applied to other 5G use scenarios not illustrated in FIG. 1.

The three main categories of requirements for 5G are: (1) enhanced Mobile Broadband (eMBB), (2) massive Machine Type Communication (mMTC), and (3) Ultra-Reliable and Low Latency Communications (URLLC).

Referring to FIG. 1, a communication system 1 includes wireless devices 100a to 100f, a base station (BS) 200, and a network 300. Although FIG. 1 illustrates a 5G network as an example of the network of the communication system 1, the embodiments of the present disclosure are not limited to the 5G system and may be applied to future communication systems beyond 5G.

The BS 200 and the network 300 may be implemented as wireless devices, and a particular wireless device may operate as a BS or a network node with respect to another wireless device.

The wireless devices 100a to 100f represent devices that perform communication using a Radio Access Technology (RAT) (e.g., 5G NR or LTE), and may also be referred to as communication/wireless/5G devices. The wireless devices 100a to 100f may include, but are not limited to, a robot 100a, vehicles 100b-1 and 100b-2, an extended reality (XR) device 100c, a portable device 100d, a home appliance 100e, an Internet of Things (IoT) device 100f, and an artificial intelligence (AI) device/server 400. For example, the vehicles may include vehicles having wireless communication capabilities, autonomous vehicles, and vehicles capable of performing vehicle-to-vehicle communication. The vehicles may include an unmanned aerial vehicle (UAV) (e.g., a drone). The XR device may include an augmented reality (AR), virtual reality (VR), and/or mixed reality (MR) device, and may be implemented in the form of a head-mounted device (HMD) or a head-up display (HUD) mounted on a vehicle, television, smartphone, computer, wearable device, home appliance, digital signage, vehicle, or robot. The portable device may include a smartphone, a smart pad, a wearable device (e.g., a smart watch or smart glasses), and a computer (e.g., a laptop). The home appliances may include a television (TV), a refrigerator, and a washing machine. The IoT devices may include sensors and smart meters.

In the present disclosure, the wireless devices 100a to 100f may also be referred to as user equipment (UE). The UE may include, for example, a mobile phone, a smartphone, a notebook computer, a digital broadcasting terminal, a personal digital assistant (PDA), a portable multimedia player (PMP), a navigation system, a slate PC, a tablet PC, an ultrabook, a vehicle, a vehicle having an autonomous driving function, a connected car, a UAV, an AI module, a robot, an AR device, a VR device, an MR device, a hologram device, a public safety device, an MTC device, an IoT device, a medical device, a fintech (financial technology) device, a security device, a weather/environmental device, a 5G service-related device, or a device related to the fourth industrial revolution.

For example, a UAV may be an aircraft that is navigated by a wireless control signal without a human on board.

For example, a VR device may include a device for implementing objects or backgrounds of a virtual environment. For example, an AR device may include a device for implementing objects or backgrounds of a virtual world by linking the objects or backgrounds to objects or backgrounds of the real world. For example, an MR device may include a device for implementing objects or backgrounds of a virtual world by merging the objects or backgrounds with objects or backgrounds of the real world. For example, a hologram device may include a device for implementing a 360-degree three-dimensional image by recording and reproducing three-dimensional information using the light interference phenomenon generated when two laser beams, referred to as a hologram, meet.

For example, a public safety device may include an image transmission device or an imaging device capable of being worn on a user body.

For example, an MTC or IoT device may be a device that does not require direct human intervention or manipulation. For example, the MTC or IoT device may include smart meters, vending machines, thermometers, smart light bulbs, door locks, or various sensors.

For example, a medical device may be a device used for diagnosing, treating, alleviating, curing, or preventing a disease. For example, the medical device may be a device used for diagnosing, treating, alleviating, or correcting an injury or damage. For example, the medical device may be a device used for inspecting, replacing, or modifying a structure or function.

For example, the medical device may be a device used for contraception. For example, the medical device may include a therapeutic device, a driving device, an (in vitro) diagnostic device, a hearing aid, or a surgical device.

For example, a security device may be a device installed to prevent potential hazards and maintain safety. For example, the security device may be a camera, a closed-circuit television (CCTV), a recorder, or a black box.

For example, a fintech device may be a device capable of providing financial services such as mobile payment. For example, the fintech device may include a payment device or a point of sale (POS) system.

For example, a weather/environmental device may include a device for monitoring or predicting weather/environmental conditions.

The wireless devices 100a to 100f may be connected to the network 300 through the BS 200. AI technology may be applied to the wireless devices 100a to 100f, and the wireless devices 100a to 100f may be connected to an AI server 400 through the network 300. The network 300 may be configured using a 3G network, a 4G (e.g., LTE) network, a 5G (e.g., NR) network, or a network beyond 5G. The wireless devices 100a to 100f may communicate with each other through the BS 200 and/or the network 300, or may directly communicate with each other without the BS 200 and/or the network 300 (e.g., sidelink communication).

For example, the vehicles 100b-1 and 100b-2 may perform direct communication (e.g., Vehicle-to-Vehicle (V2V) and/or Vehicle-to-Everything (V2X) communication). In addition, the IoT device (e.g., a sensor) may directly communicate with another IoT device (e.g., a sensor) or other wireless devices 100a to 100f.

Wireless communications/connections 150a, 150b, and/or 150c may be established between the wireless devices 100a to 100f, between the wireless devices 100a to 100f and the BS 200, and/or between BSs 200. Here, the wireless communications/connections may be established through various RATs (e.g., 5G NR), such as UL/DL communication (150a), sidelink communication (150b) (or device-to-device (D2D) communication), and inter-BS communication (150c) (e.g., relay or Integrated Access and Backhaul (IAB)). Through the communications/connections 150a, 150b, and/or 150c, the wireless devices 100a to 100f and the BS 200 may transmit and/or receive wireless signals to and from each other. For example, the communications/connections 150a, 150b, and/or 150c may transmit and/or receive signals over various physical channels.

To this end, at least part of various configuration procedures for the transmission and reception of wireless signals, various signal processing procedures (e.g., channel encoding/decoding, modulation/demodulation, resource mapping/demapping), and resource allocation procedures may be performed based on various proposals of the present disclosure.

AI refers to a field of study that researches artificial intelligence or methodologies for creating such intelligence, and machine learning refers to a field of study that defines various problems addressed in the field of AI and researches methodologies for solving the problems. Machine learning may also be defined as an algorithm that improves performance on a given task through continuous experience.

A robot may refer to a machine that automatically performs or operates a given task based on the capabilities thereof. In particular, a robot having a function of recognizing the environment and performing operations based on autonomous judgment may be referred to as an intelligent robot. Robots may be classified as industrial, medical, domestic, or military robots, depending on the intended use or application field thereof. The robot may include a driving unit having an actuator or a motor, thereby performing various physical operations such as moving robotic joints. In addition, a mobile robot may include wheels, brakes, or propellers in the driving unit thereof, and may travel on the ground or fly in the air through the driving unit.

Autonomous driving refers to a technology that enables a vehicle to drive by itself, and an autonomous vehicle refers to a vehicle capable of driving with no or minimal user operation.

For example, autonomous driving may include technologies for maintaining a lane while driving, technologies for automatically adjusting speed such as adaptive cruise control, technologies for automatically driving along a predetermined route, and technologies for automatically determining and following a route when a destination is configured. The term “vehicle” encompasses a vehicle equipped only with an internal combustion engine, a hybrid vehicle equipped with both an internal combustion engine and an electric motor, and an electric vehicle equipped only with an electric motor. The term “vehicle” may also include not only automobiles but also trains, motorcycles, and the like. An autonomous vehicle may be regarded as a robot having an autonomous driving function.

XR is a collective term that encompasses VR, AR, and MR. VR technology provides computer-generated (CG) images of objects or backgrounds in the real world, AR technology provides CG images virtually created over real-world images, and MR technology provides CG images by mixing and combining virtual objects with the real world. MR technology is similar to AR technology in that both display real and virtual objects together. However, while AR technology uses virtual objects to complement real objects, MR technology differs in that virtual and real objects are used with equal significance.

NR supports multiple numerologies or subcarrier spacings (SCSs) to accommodate various 5G services. For example, when the SCS is 15 kHz, it supports wide-area coverage in conventional cellular bands. When the SCS is 30 kHz or 60 kHz, it supports dense-urban environments, lower latency, and wider carrier bandwidths. When the SCS is 60 kHz or higher, it supports bandwidths greater than 24.25 GHz to overcome phase noise.

The NR frequency bands may be defined as two types of frequency ranges (FR1 and FR2). The numerical values of the frequency ranges may change. For example, the two types of frequency ranges (FR1 and FR2) may be as shown in Table 1 below. For convenience of explanation, among the frequency ranges used in the NR system, FR1 may refer to a “sub-6 GHz range,” and FR2 may refer to an “above-6 GHz range,” which may also be referred to as a millimeter wave (mmW) range.

TABLE 1

| Definition of | | | |
|---|---|---|---|
| frequency ranges | Frequency ranges | SCS | |
| FR1 | 450 MHz-6000 MHz | 15, 30, 60 | kHz |
| FR2 | 24250 MHz-52600 MHz | 60, 120, 240 | kHz |

As described above, the numerical values of the frequency ranges in the NR system may change. For example, FR1 may include a band from 410 MHz to 7125 MHz, as shown in Table 2 below. That is, FR1 may include frequency bands above 6 GHz (or 5850, 5900, or 5925 MHz). For example, frequency bands above 6 GHz (or 5850, 5900, or 5925 MHz) included in FR1 may include unlicensed bands. The unlicensed bands may be used for various purposes, for example, for communication for vehicles (e.g., autonomous driving).

TABLE 2

| Definition of | | | |
|---|---|---|---|
| frequency ranges | Frequency ranges | SCS | |
| FR1 | 410 MHz-7125 MHz | 15, 30, 60 | kHz |
| FR2 | 24250 MHz-52600 MHz | 60, 120, 240 | kHz |

The wireless communication technologies implemented in the wireless device of the present disclosure may include not only LTE, NR, and 6G but also NarrowBand Internet of Things (NB-IoT) for low-power communication. For example, NB-IoT technology may be an example of Low Power Wide Area Network (LPWAN) technology. NB-IoT technology may be implemented according to standards such as LTE Cat NB1 and/or LTE Cat NB2, but NB-IoT technology is not limited to the above names. Additionally or alternatively, the wireless communication technologies implemented in the wireless device of the present disclosure may perform communication based on TE for Machine-Type Communication (LTE-M) technology. For example, LTE-M technology may be an example of LPWAN technology and may be referred to by various names such as enhanced Machine Type Communication (eMTC). For example, LTE-M technology may be implemented according to at least one of various standards such as 1) LTE Cat 0, 2) LTE Cat M1, 3) LTE Cat M2, 4) LTE non-BL (Non-Bandwidth Limited), 5) LTE-MTC, 6) LTE MTC, and/or 7) LTE M, but LTE-M technology is not limited to the above names. Additionally or alternatively, the wireless communication technologies implemented in the wireless device of the present disclosure may include at least one of ZigBee, Bluetooth, and/or LPWAN, which are considered for low-power communication, but the wireless communication technologies are not limited to the above names. For example, ZigBee technology may generate Personal Area Networks (PANs) related to small-scale/low-power digital communication based on various standards such as IEEE 802.15.4, and ZigBee technology may be referred to by various names.

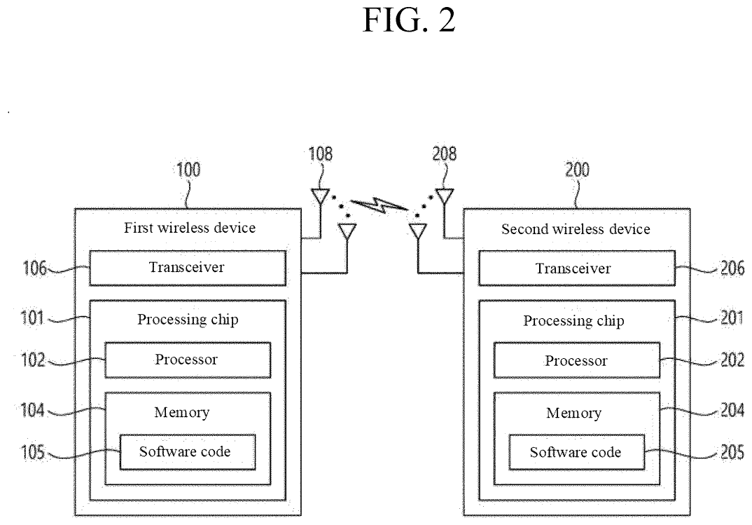

FIG. 2 illustrates an example of a wireless device to which an implementation of the present disclosure is applied.

Referring to FIG. 2, a first wireless device 100 and a second wireless device 200 may transmit and receive wireless signals to and from an external device through various RATs (e.g., LTE and NR).

In FIG. 2, the first wireless device 100 and the second wireless device 200 may correspond to at least one of {the wireless devices 100a to 100f and the BS 200}, {the wireless devices 100a to 100f and the wireless devices 100a to 100f}, and/or {the BS 200 and the BS 200} shown in FIG. 1.

The first wireless device 100 may include at least one transceiver such as a transceiver 106, at least one processing chip such as a processing chip 101, and/or one or more antennas 108.

The processing chip 101 may include at least one processor such as a processor 102 and at least one memory such as a memory 104. In FIG. 2, the memory 104 is illustrated as being included in the processing chip 101. Additionally or alternatively, the memory 104 may be disposed outside the processing chip 101.

The processor 102 may control the memory 104 and/or the transceiver 106, and may be configured to implement the descriptions, functions, procedures, proposals, methods, and/or operation flowcharts described in the present disclosure. For example, the processor 102 may process information stored in the memory 104 to generate first information and/or a first signal, and may transmit a wireless signal including the first information and/or the first signal through the transceiver 106. The processor 102 may receive, through the transceiver 106, a wireless signal including second information and/or a second signal, and may store in the memory 104 information obtained by processing the second information and/or the second signal.

The memory 104 may be operably connected to the processor 102.

The memory 104 may store various types of information and/or instructions. The memory 104 may store software code 105 that implements instructions for performing the descriptions, functions, procedures, proposals, methods, and/or operation flowcharts described in the present disclosure when executed by the processor 102. For example, when executed by the processor 102, the software code 105 may implement instructions for performing the descriptions, functions, procedures, proposals, methods, and/or operation flowcharts described in the present disclosure. For example, the software code 105 may control the processor 102 to perform one or more protocols. For example, the software code 105 may control the processor 102 to perform one or more wireless interface protocol layers.

Here, the processor 102 and the memory 104 may be part of a communication modem, circuit, or chip designed to implement a RAT (e.g., LTE or NR). The transceiver 106 may be connected to the processor 102 and may transmit and/or receive wireless signals through the one or more antennas 108. Each transceiver 106 may include a transmitter and/or a receiver. The transceiver 106 may be interchangeably referred to as a Radio Frequency (RF) unit. In the present disclosure, the first wireless device 100 may represent a communication modem, circuit, or chip.

The second wireless device 200 may include at least one transceiver such as a transceiver 206, at least one processing chip such as a processing chip 201, and/or one or more antennas 208.

The processing chip 201 may include at least one processor such as a processor 202 and at least one memory such as a memory 204. In FIG. 2, the memory 204 is illustrated as being included in the processing chip 201. Additionally or alternatively, the memory 204 may be disposed outside the processing chip 201.

The processor 202 may control the memory 204 and/or the transceiver 206, and may be configured to implement the descriptions, functions, procedures, proposals, methods, and/or operation flowcharts described in the present disclosure. For example, the processor 202 may process information stored in the memory 204 to generate third information and/or a third signal, and may transmit a wireless signal including the third information and/or the third signal through the transceiver 206. The processor 202 may receive, through the transceiver 206, a wireless signal including fourth information and/or a fourth signal, and may store in the memory 204 information obtained by processing the fourth information and/or the fourth signal.

The memory 204 may be operably connected to the processor 202.

The memory 204 may store various types of information and/or instructions. The memory 204 may store software code 205 that implements instructions for performing the descriptions, functions, procedures, proposals, methods, and/or operation flowcharts described in the present disclosure when executed by the processor 202. For example, when executed by the processor 202, the software code 205 may implement instructions for performing the descriptions, functions, procedures, proposals, methods, and/or operation flowcharts described in the present disclosure. For example, the software code 205 may control the processor 202 to perform one or more protocols. For example, the software code 205 may control the processor 202 to perform one or more wireless interface protocol layers.

Here, the processor 202 and the memory 204 may be part of a communication modem, circuit, or chip designed to implement a RAT (e.g., LTE or NR). The transceiver 206 may be connected to the processor 202 and may transmit and/or receive wireless signals through the one or more antennas 208. Each transceiver 206 may include a transmitter and/or a receiver. The transceiver 206 may be interchangeably referred to as an RF unit. In the present disclosure, the second wireless device 200 may represent a communication modem, circuit, or chip.

Hereinafter, the hardware elements of the wireless devices 100 and 200 will be described in more detail. Without being limited thereto, one or more protocol layers may be implemented by one or more processors 102 and 202. For example, the one or more processors 102 and 202 may implement one or more layers (e.g., functional layers such as a Physical (PHY) layer, a Media Access Control (MAC) layer, a Radio Link Control (RLC) layer, a Packet Data Convergence Protocol (PDCP) layer, a Radio Resource Control (RRC) layer, and a Service Data Adaptation Protocol (SDAP) layer). The one or more processors 102 and 202 may generate one or more Protocol Data Units (PDUs) and/or one or more Service Data Units (SDUs) according to the descriptions, functions, procedures, proposals, methods, and/or operation flowcharts described in the present disclosure. The one or more processors 102 and 202 may generate messages, control information, data, or information according to the descriptions, functions, procedures, proposals, methods, and/or operation flowcharts described in the present disclosure. The one or more processors 102 and 202 may generate a signal (e.g., a baseband signal) including a PDU, an SDU, a message, control information, data, or information according to the descriptions, functions, procedures, proposals, methods, and/or operation flowcharts described in the present disclosure, and may provide the generated signal to one or more transceivers 106 and 206. The one or more processors 102 and 202 may receive a signal (e.g., a baseband signal) from the one or more transceivers 106 and 206 and may acquire a PDU, an SDU, a message, control information, data, or information according to the descriptions, functions, procedures, proposals, methods, and/or operation flowcharts described in the present disclosure.

The one or more processors 102 and 202 may be referred to as a controller, a microcontroller, a microprocessor, and/or a microcomputer. The one or more processors 102 and 202 may be implemented by hardware, firmware, software, and/or a combination thereof. For example, one or more Application Specific Integrated Circuits (ASICs), one or more Digital Signal Processors (DSPs), one or more Digital Signal Processing Devices (DSPDs), one or more Programmable Logic Devices (PLDs), and/or one or more Field Programmable Gate Arrays (FPGAs) may be included in the one or more processors 102 and 202. The descriptions, functions, procedures, proposals, methods, and/or operation flowcharts described in the present disclosure may be implemented using firmware and/or software, and the firmware and/or software may be implemented to include modules, procedures, and functions. The firmware or software configured to perform the descriptions, functions, procedures, proposals, methods, and/or operation flowcharts described in the present disclosure may be included in the one or more processors 102 and 202, or may be stored in one or more memories 104 and 204 and operated by the one or more processors 102 and 202. The descriptions, functions, procedures, proposals, methods, and/or operation flowcharts described in the present disclosure may be implemented using firmware or software in the form of code, instructions, and/or sets of instructions.

The one or more memories 104 and 204 may be connected to the one or more processors 102 and 202 and may store various types of data, signals, messages, information, programs, codes, directives, and/or instructions. The one or more memories 104 and 204 may include a Read-Only Memory (ROM), a Random Access Memory (RAM), an Erasable Programmable Read-Only Memory (EPROM), a flash memory, a hard drive, a register, a cache memory, a computer-readable storage medium, and/or a combination thereof. The one or more memories 104 and 204 may be located inside and/or outside the one or more processors 102 and 202. In addition, the one or more memories 104 and 204 may be connected to the one or more processors 102 and 202 through various technologies such as wired or wireless connections.

The one or more transceivers 106 and 206 may transmit to one or more other devices user data, control information, wireless signals, channels, and the like mentioned in the descriptions, functions, procedures, proposals, methods, and/or operation flowcharts described in the present disclosure. The one or more transceivers 106 and 206 may receive from one or more other devices user data, control information, wireless signals, channels, and the like mentioned in the descriptions, functions, procedures, proposals, methods, and/or operation flowcharts described in the present disclosure. For example, the one or more transceivers 106 and 206 may be connected to the one or more processors 102 and 202, and may transmit and receive wireless signals. For example, the one or more processors 102 and 202 may control the one or more transceivers 106 and 206 to transmit user data, control information, wireless signals, and the like to one or more other devices. In addition, the one or more processors 102 and 202 may control the one or more transceivers 106 and 206 to receive user data, control information, wireless signals, and the like from one or more other devices.

The one or more transceivers 106 and 206 may be connected to one or more antennas 108 and 208. The one or more transceivers 106 and 206 may be configured to transmit and receive, through the one or more antennas 108 and 208, user data, control information, wireless signals, channels, and the like mentioned in the descriptions, functions, procedures, proposals, methods, and/or operation flowcharts described in the present disclosure. In the present disclosure, the one or more antennas 108 and 208 may be a plurality of physical antennas or a plurality of logical antennas (e.g., antenna ports).

The one or more transceivers 106 and 206 may convert received user data, control information, wireless signals, channels, and the like from an RF band signal into a baseband signal to process the received user data, control information, wireless signals, channels, and the like using the one or more processors 102 and 202. The one or more transceivers 106 and 206 may convert user data, control information, wireless signals, channels, and the like processed by the one or more processors 102 and 202 from a baseband signal into an RF band signal. To this end, the one or more transceivers 106 and 206 may include an (analog) oscillator and/or a filter. For example, the one or more transceivers 106 and 206 may, under the control of the one or more processors 102 and 202, up-convert an OFDM baseband signal into an OFDM signal through the (analog) oscillator and/or filter, and transmit the up-converted OFDM signal at a carrier frequency. The one or more transceivers 106 and 206 may receive an OFDM signal at a carrier frequency and, under the control of one or more processors 102 and 202, down-convert the OFDM signal into an OFDM baseband signal through the (analog) oscillator and/or filter.

In an implementation of the present disclosure, a UE may operate as a transmitting device in UL and as a receiving device in DL. In an implementation of the present disclosure, a BS may operate as a receiving device in UL and as a transmitting device in DL. For convenience of description, it is mainly assumed that the first wireless device 100 operates as a UE and the second wireless device 200 operates as a BS. For example, the processor 102 connected to, mounted on, or released with the first wireless device 100 may be configured to perform UE operations according to an implementation of the present disclosure or control the transceiver 106 to perform UE operations according to an implementation of the present disclosure. The processor 202 connected to, mounted on, or released with the second wireless device 200 may be configured to perform BS operations according to an implementation of the present disclosure or control the transceiver 206 to perform BS operations according to an implementation of the present disclosure.

In the present disclosure, the BS may be referred to as a Node B, an eNode B (eNB), or a gNode B (gNB).

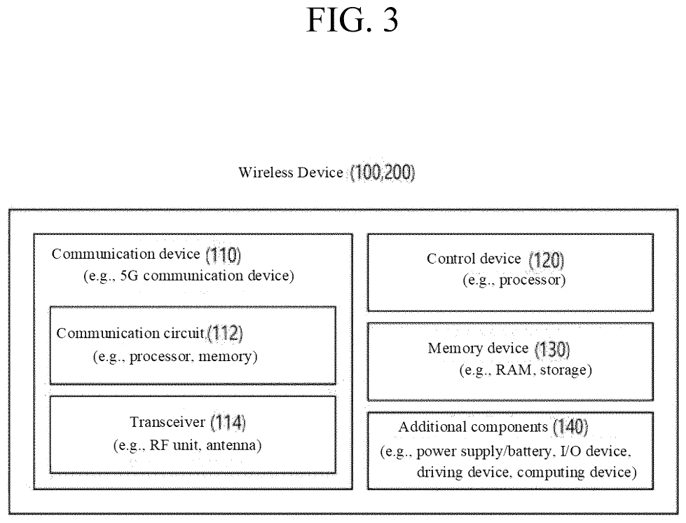

FIG. 3 illustrates an example of a wireless device to which an implementation of the present disclosure is applied.

The wireless device may be implemented in various forms depending on use cases/services (see FIG. 1).

Referring to FIG. 3, wireless devices 100 and 200 may correspond to the wireless devices 100 and 200 of FIG. 2. The wireless devices 100 and 200 may be configured with various components, devices/parts, and/or modules. For example, each of the wireless devices 100 and 200 may include a communication device 110, a control device 120, a memory device 130, and additional components 140. The communication device 110 may include a communication circuit 112 and a transceiver 114. For example, the communication circuit 112 may include the one or more processors 102 and 202 and/or the one or more memories 104 and 204 of FIG. 2. For example, the transceiver 114 may include the one or more transceivers 106 and 206 and/or the one or more antennas 108 and 208 of FIG. 2. The control device 120 is electrically connected to the communication device 110, the memory device 130, and the additional components 140, and controls the overall operation of each of the wireless devices 100 and 200. For example, the control device 120 may control the electrical and mechanical operations of each of the wireless devices 100 and 200 based on programs, codes, commands, and/or information stored in the memory device 130. The control device 120 may transmit information stored in the memory device 130 to the outside (e.g., another communication device) through the communication device 110 via a wireless/wired interface, or may store, in the memory device 130, information received from the outside (e.g., another communication device) through the communication device 110 via a wireless/wired interface.

The additional components 140 may be variously configured depending on the types of the wireless devices 100 and 200. For example, the additional components 140 may include at least one of a power supply or battery, an input/output (I/O) device (e.g., an audio I/O port or a video I/O port), a driving device, or a computing device. The wireless devices 100 and 200 may be implemented, without being limited thereto, in the form of a robot (100a in FIG. 1), vehicles (100b-1 and 100b-2 in FIG. 1), an XR device (100c in FIG. 1), a portable device (100d in FIG. 1), a home appliance (100e in FIG. 1), an IoT device (100f in FIG. 1), a digital broadcasting terminal, a hologram device, a public safety device, an MTC device, a medical device, a fintech (or financial) device, a security device, a climate/environmental device, an AI server/device (400 in FIG. 1), a BS (200 in FIG. 1), or a network node. The wireless devices 100 and 200 may be used at a mobile or fixed location depending on use cases/services.

In FIG. 3, all of the various components, devices/parts, and/or modules of the wireless devices 100 and 200 may be connected to each other through a wired interface, or at least some thereof may be wirelessly connected through the communication device 110. For example, in each of the wireless devices 100 and 200, the control device 120 and the communication device 110 may be connected by wire, and the control device 120 and a first device (e.g., the devices 130 and 140) may be wirelessly connected through the communication device 110. Each component, device/part, and/or module in the wireless devices 100 and 200 may further include one or more elements. For example, the control device 120 may be configured with a set of one or more processors. For example, the control device 120 may be configured with a set of processors including a communication control processor, an application processor (AP), an electronic control unit (ECU), a graphics processing unit (GPU), and a memory control processor.

As another example, the memory device 130 may be configured with a RAM, a Dynamic RAM (DRAM), a ROM, a flash memory, a volatile memory, a non-volatile memory, and/or a combination thereof.

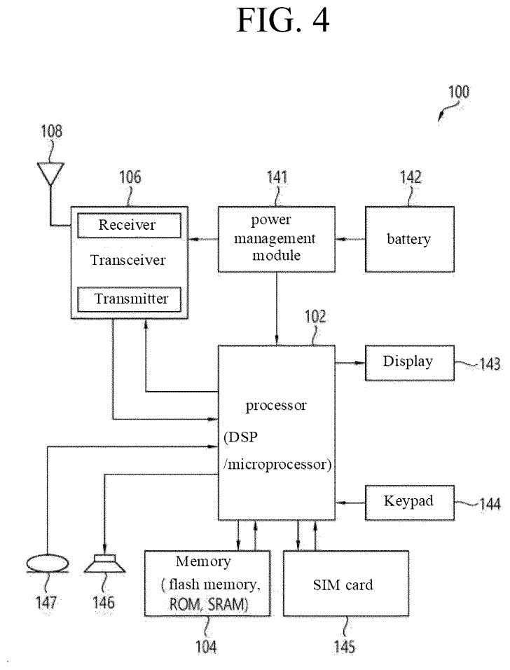

FIG. 4 illustrates an example of a UE to which an implementation of the present disclosure is applied.

Referring to FIG. 4, a UE 100 may correspond to the first wireless device 100 of FIG. 2 and/or the wireless device 100 or 200 of FIG. 3.

The UE 100 includes a processor 102, a memory 104, a transceiver 106, one or more antennas 108, a power management module 141, a battery 142, a display 143, a keypad 144, a Subscriber Identity Module (SIM) card 145, a speaker 146, and a microphone 147.

The processor 102 may be configured to implement the descriptions, functions, procedures, proposals, methods, and/or operation flowcharts described in the present disclosure. The processor 102 may be configured to control one or more other components of the UE 100 to implement the descriptions, functions, procedures, proposals, methods, and/or operation flowcharts described in the present disclosure. Wireless interface protocol layers may be implemented in the processor 102. The processor 102 may include an ASIC, a chipset, a logic circuit, and/or a data processing device. The processor 102 may be an application processor. The processor 102 may include at least one of a DSP, a Central Processing Unit (CPU), a GPU, and a modem (modulator and demodulator). Examples of the processor 102 may include SNAPDRAGON™ series processors manufactured by Qualcomm®, EXYNOS™ series processors manufactured by Samsung®, A series processors manufactured by Apple®, HELIO™ series processors manufactured by MediaTek®, ATOM™ series processors manufactured by Intel®, or corresponding next-generation processors.

The memory 104 is operably coupled to the processor 102 and stores various information for operating the processor 102. The memory 104 may include a ROM, a RAM, a flash memory, a memory card, a storage medium, and/or other storage devices. When implemented in software, the techniques described herein may be implemented using modules (e.g., procedures, functions, etc.) that perform the descriptions, functions, procedures, proposals, methods, and/or operation flowcharts described in the present disclosure. The modules may be stored in the memory 104 and executed by the processor 102. The memory 104 may be implemented within or external to the processor 102. In the latter case, the memory 104 may be communicatively coupled to the processor 102 by various known techniques.

The transceiver 106 is operably coupled to the processor 102 and transmits and/or receives radio signals. The transceiver 106 includes a transmitter and a receiver. The transceiver 106 may include a baseband circuit for processing radio frequency signals. The transceiver 106 controls the one or more antennas 108 to transmit and/or receive radio signals.

The power management module 141 manages power for the processor 102 and/or the transceiver 106. The battery 142 supplies power to the power management module 141.

The display 143 outputs results processed by the processor 102.

The keypad 144 receives input to be used by the processor 102. The keypad 144 may be displayed on the display 143.

The SIM card 145 is an integrated circuit for securely storing an International Mobile Subscriber Identity (IMSI) and related keys, and is used to identify and authenticate a subscriber in a mobile device such as a mobile phone or a computer. In addition, many SIM cards may also store contact information.

The speaker 146 outputs sound-related results processed by the processor 102. The microphone 147 receives sound-related input to be used by the processor 102.

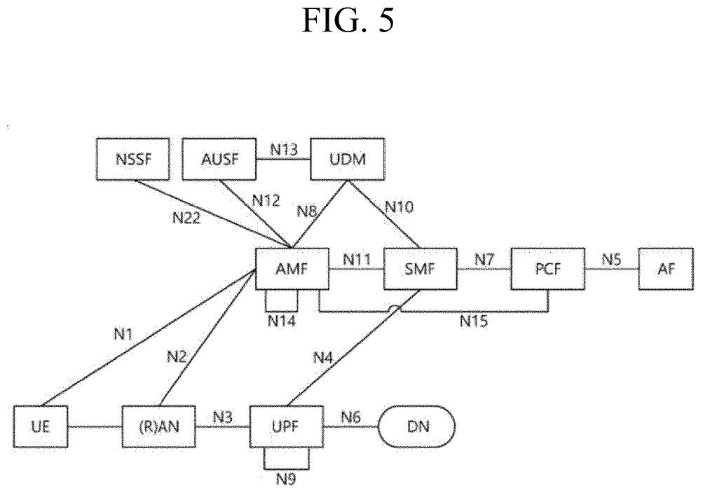

FIG. 5 illustrates an example of a 5G system architecture to which an implementation of the present disclosure is applied.

The 5G System (5GS) architecture is composed of the following Network Functions (NFs).
AUSF (Authentication Server Function)
AMF (Access and Mobility Management Function)
DN (Data Network): for example, an operator service, Internet access, or a third-party service.
UDSF (Unstructured Data Storage Function)
NEF (Network Exposure Function)
I-NEF (Intermediate NEF)
NRF (Network Repository Function)
NSSF (Network Slice Selection Function)
PCF (Policy Control Function)
SMF (Session Management Function)
UDM (Unified Data Management)
UDR (Unified Data Repository)
UPF (User Plane Function)
UCMF (UE radio Capability Management Function)
AF (Application Function)
UE (User Equipment)
(R)AN ((Radio) Access Network)
5G-EIR (5G-Equipment Identity Register)
NWDAF (Network Data Analytics Function)
CHF (CHarging Function)
In addition, the following NFs may be considered.
N3IWF (Non-3GPP InterWorking Function)
TNGF (Trusted Non-3GPP Gateway Function)
W-AGF (Wireline Access Gateway Function)

FIG. 5 illustrates a 5GS architecture in a non-roaming case, using a reference point representation that shows how various NFs interact with each other.

In FIG. 5, the UDSF, NEF, and NRF are not described for clarity of the point-to-point illustration. However, all illustrated NFs may interact with the UDSF, UDR, NEF, and NRF as necessary.

For clarity, the connection between the UDR and other NFs (e.g., the PCF) is not shown in FIG. 5. For clarity, the connection between the NWDAF and other NFs (e.g., the PCF) is not shown in FIG. 5.

The 5GS architecture includes the following reference points:
N1: Reference point between the UE and the AMF.
N2: Reference point between the (R)AN and the AMF.
N3: Reference point between the (R)AN and the UPF.
N4: Reference point between the SMF and the UPF.
N6: Reference point between the UPF and the data network.
N9: Reference point between two UPFs.

The following reference points represent interactions between NF services of different NFs:
N5: Reference point between the PCF and the AF.
N7: Reference point between the SMF and the PCF.
N8: Reference point between the UDM and the AMF.
N10: Reference point between the UDM and the SMF.
N11: Reference point between the AMF and the SMF.
N12: Reference point between the AMF and the AUSF.
N13: Reference point between the UDM and the AUSF.
N14: Reference point between two AMFs.
N15: Reference point between the PCF and the AMF in a non-roaming scenario, or between the PCF and the AMF in the visited network in a roaming scenario.
N16: Reference point between two SMFs (in the case of roaming, between the SMF in the visited network and the SMF in the home network).
N22: Reference point between the AMF and the NSSF.

In some cases, two NFs may need to be interconnected to serve the UE.

Meanwhile, extensive discussions are being conducted to enhance network energy efficiency in the 5GS. Discussions on energy-related topics are also ongoing in 3GPP. However, discussions on energy efficiency have mainly focused on improving energy efficiency by reducing transmission and reception frequency such as through Discontinuous Reception (DRX) and Discontinuous Transmission (DTX) and/or by improving energy efficiency from the operational perspective rather than from the system design perspective. Nevertheless, it is not easy to incorporate energy efficiency into system design, to provide industry access to information on network energy efficiency, or to introduce energy efficiency as a service (for example, transmission rate management according to battery conditions).

In addition, interest in the use of renewable energy and carbon emission reduction has been increasing for sustainable development, such as ESG (Environment, Social, and Governance) management. However, a 5G network has no function for providing energy information such as energy usage, energy source information, or carbon emission to external third-party AFs or application servers. Furthermore, there is no method for an AF to check energy source information within the network. Research on energy efficiency as a service criterion is also being conducted in 3GPP. In addition, in the 5GS, it may be necessary to structurally expose and exchange energy information of servers and networks and manage energy usage.

In addition, the 5GS does not collect or manage energy efficiency or status information of servers or UEs. In next-generation wireless communication systems, it may be necessary to manage transmission amount and quality of service (QoS) by identifying the energy efficiency of servers and the battery status or energy efficiency of UEs.

In the conventional 5G system, the AF did not have a function to provide network energy information, and the system may not identify the energy information of the AF or the energy level of the UE. If a new network function of a 5G core capable of exposing and exchanging energy information such as energy sources, carbon emissions, and energy consumption between the 5G network and the AF is defined, energy information may be exchanged between the 5G system and third-party AFs. Based on the exchanged information, transmission rates may be adjusted, for example, by guaranteeing higher QoS performance to AFs that use renewable energy or emit less carbon.

Accordingly, an Energy Information Repository Function (EIRF) having a new network function capable of exposing energy information to an AF, collecting energy-related information of the AF, and storing and managing energy information may be defined in a next-generation wireless communication system including a 5G system. The term “EIRF” is arbitrarily named in the present disclosure, and the name of the function may be variously changed, for example, to an Energy Efficiency Control Function (EECF). The EIRF may perform various energy-related functions, such as utilizing energy as a performance criterion for optimal communication, supporting various energy-efficiency modes in industrial campuses, exposing energy usage based on possible deployment scenarios, exposing energy usage information according to Non-Public Network (NPN) execution sharing, service energy monitoring by an application server, exposing energy usage information considering QoS, support for service-level energy efficiency analysis by industry, monitoring application energy efficiency, exposing renewable energy usage information, and supporting carbon-aware communication services.

In addition, the EIRF may provide energy information of a UE to a third-party AF, and the AF may acquire and monitor energy information from the 5G system. The AF may perform the system configuration based on energy efficiency, such as charging or restricting services according to the energy information. Furthermore, based on the above function, the AF may adjust service provision, such as video playback, by checking energy source information or carbon emission information.

For example, the EIRF may include, store, and provide the following information. The information described below is merely an example, and the EIRF may include any other information necessary for energy management and energy control in addition to the information disclosed in the present disclosure.

The EIRF may include, store, and provide energy information that an AF is capable of providing to a 5G system. For example, the information may include information on energy sources such as renewable energy and thermal energy, information on power consumption, and information on carbon emissions. In addition, the EIRF may include, store, and provide energy information that the network provides to the AF. For example, the information may include information on energy sources, energy information of UEs, energy information of the UPF in use, information on power consumption, and information on carbon emissions.

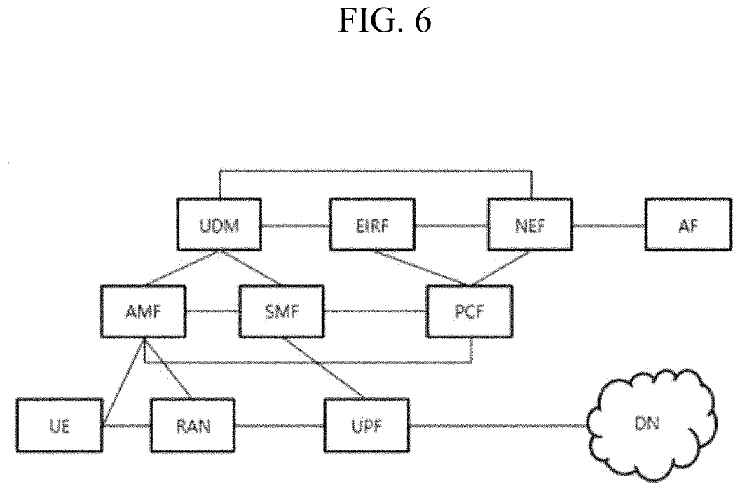

FIG. 6 illustrates an example of a 5G system architecture in which an EIRF is added.

Referring to FIG. 6, the EIRF may interact with a NEF, a PCF, a UDM, and the like.

For example, through the PCF, energy-related policies such as energy consumption and types of energy used may be determined, and the corresponding policies may be delivered to and applied by the EIRF. In addition, subscription information of a UE related to energy, such as pricing plans and charging policies, may be managed by the UDM. Furthermore, the NEF may store energy-related information provided by the EIRF as structured data and expose the energy-related information to other network functions. FIG. 6 merely illustrates an example of a 5G system architecture including the EIRF, but unlike the configuration illustrated in FIG. 6, the EIRF may interact with various network functions of the 5G system and/or next-generation wireless communication systems.

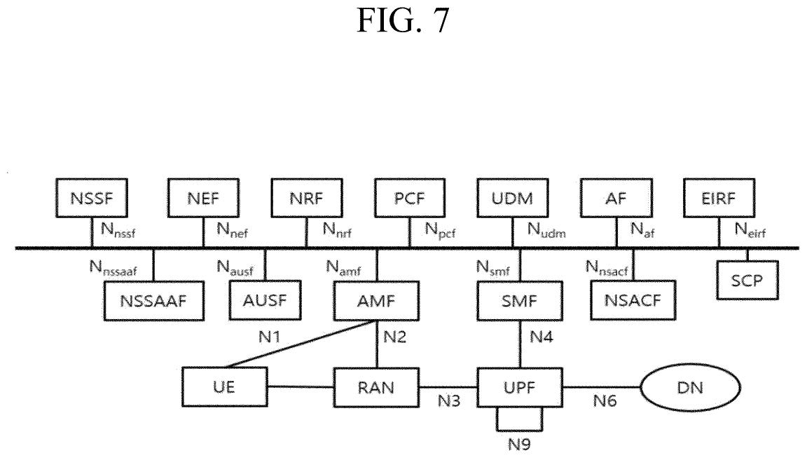

FIG. 7 illustrates another example of a 5G system architecture in which an EIRF is added.

FIG. 7 illustrates Namf (a service-based interface provided by an AMF), Nnef (a service-based interface provided by an NEF), Nnrf (a service-based interface provided by an NRF), Npcf (a service-based interface provided by a PCF), Nudm (a service-based interface provided by a UDM), Naf (a service-based interface exposed by an AF), Nnssaaf (a service-based interface provided by an NSSAAF), Nausf (a service-based interface exposed by an AUSF), Namf (a service-based interface provided by the AMF), Nsmf (a service-based interface provided by an SMF), and Nnsacf (a service-based interface provided by an NSACF). Referring to FIG. 7, the service-based interface provided by the EIRF may be named Neirf. As described above, the EIRF and Neirf may also be referred to by other names.

Referring to FIG. 7, the EIRF may be interconnected with other network functions through a common bus. For example, the EIRF may register services provided by the EIRF with the NRF. Subsequently, the EIRF may use the NRF as a database to search for other network functions and services provided by the other network functions. In addition, the EIRF may obtain service authorization from the NRF in order to use the services provided by the other network functions. The EIRF may use Hypertext Transfer Protocol version 2 (HTTP/2) to perform signaling with the other network functions.

In an embodiment, the EIRF may acquire and store information from one or more of the AMF, SMF, UPF, or RAN based on a request from the AF. For example, when the EIRF receives a request from the AF, the EIRF may collect, through and an Operation, Administration, and Maintenance (OAM), energy consumption-related information per Network Function (NF) or per Single Network Slice Selection Assistance Information (S-NSSAI) (for example, energy efficiency information, energy consumption information of the RAN, or renewable energy information of the corresponding area) and generate necessary information.

For example, the EIRF may acquire, from the AMF, the number of registered subscribers, DRX information of UEs, and paging-related information. The EIRF may acquire, from the SMF, the number of PDU sessions and QoS parameters for each PDU session. The EIRF may acquire, from the UPF, a data volume and a bit rate. The EIRF may acquire, from the RAN, information on data amount.

In the foregoing description, the NF for network energy management has been described as a single entity (e.g., the EIRF). However, the NF for network energy management may be formed as a plurality of entities according to the functions.

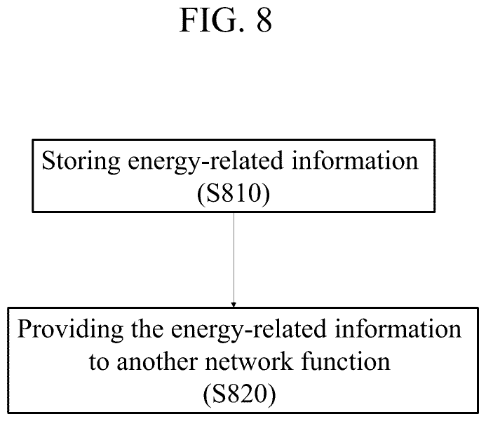

For example, entities that perform energy management on a per-NF basis, on a per-network slice basis, or on a per-service basis may be separately defined, or may be defined as types of such NFs. FIG. 8 is a flowchart illustrating operations of a network function according to some implementations of the present disclosure. Here, the network function may be the EIRF proposed in the present disclosure. In addition, some of the steps in the flowchart of FIG. 8 may be omitted or not performed, and the order of the steps may be changed.

Referring to FIG. 8, the network function may store energy-related information (S810). The network function may receive the energy-related information from another network function. In addition, the energy-related information may include energy information provided by an AF to a 5G system. For example, the energy information may include information on energy sources such as renewable energy and thermal energy, information on power consumption, and information on carbon emissions. Furthermore, the energy-related information may include energy information provided by the network to the AF. For example, the energy information may include information on energy sources, energy information of a UE, energy information of a UPF in use, information on power consumption, and information on carbon emissions. Furthermore, the energy-related information may include all information related to power and/or energy, such as energy management and power or energy saving.

The network function may provide the energy-related information to another network function (S820). Here, the other network function may include a third-party AF, a network function defined in the 5G system, and/or a network function defined in a next-generation wireless communication system. Upon receiving the energy-related information, the other network function may provide a service related to energy saving or energy management based on the energy-related information, or may perform control related to energy saving or energy management based on the energy-related information.

The methods proposed in the present disclosure may also be implemented not only by a communication device but also by an apparatus configured to control the communication device. The apparatus may include: at least one computer-readable medium including instructions based on execution by at least one processor; one or more processors; and one or more memories operably connected to the one or more processors and configured to store the instructions. The one or more processors are configured to control the communication device by executing the instructions to perform the methods proposed in the present disclosure.

The claims described in the present disclosure may be combined in various ways.

For example, the technical features of the method claims of the present disclosure may be combined and implemented as an apparatus, and the technical features of the apparatus claims of the present disclosure may be combined and implemented as a method. In addition, the technical features of the method claims and the technical features of the apparatus claims of the present disclosure may be combined and implemented as an apparatus, and the technical features of the method claims and the technical features of the apparatus claims may be combined and implemented as a method.

### INDUSTRIAL APPLICABILITY

The energy information management method and apparatus according to the embodiments of the present disclosure described above may be utilized for network energy saving in 3GPP and may be applied to 5G-A or 6G standards. However, the method and apparatus may also be widely utilized for network energy saving not only in 3GPP-based standard technologies but also in various mobile communication standards.

1. A method performed by a network in a wireless communication system, the method comprising:
receiving, by a first network function, energy-related information from a User Plane Function (UPF), a Session Management Function (SMF), and an Operation, Administration, and Maintenance (OAM),
wherein the first network function has a direct or indirect interface with a Network Exposure Function (NEF), a Policy Control Function (PCF), a Unified Data Management (UDM), an Access and Mobility Management Function (AMF), the SMF, and the UPF; and
providing the energy-related information to a second network function,
wherein the first network function provides a service related to collection and exposure of the energy-related information.

2. The method of claim 1, wherein the first network function comprises an Energy Information Repository Function (EIRF), and
wherein the second network function comprises an Application Function (AF).

3. The method of claim 1, wherein the first network function receives energy consumption-related information per Network Function (NF) or per Single Network Slice Selection Assistance Information (S-NSSAI) from the OAM.

4. The method of claim 1, wherein the first network function receives data volume information from the UPF, and
wherein the first network function receives Protocol Data Unit (PDU) session-related information from the SMF.

5. The method of claim 1, wherein the energy-related information comprises energy information provided by the network to an Application Function (AF).

6. The method of claim 1, wherein the first network function performs the energy-related information on a Network Function (NF) basis, a network slice basis, or a service basis.

7. The method of claim 2, wherein the second network function further comprises a third-party AF.

8. A method performed by a User Equipment (UE) in a wireless communication system,
providing, by the UE having an interface with an Access and Mobility Management Function (AMF), energy information related to the UE to a first network function; and
performing communication with a network operated based on information provided by the first network function,
wherein the first network function has a direct or indirect interface with a Network Exposure Function (NEF), a Policy Control Function (PCF), a Unified Data Management (UDM), the AMF, a Session Management Function (SMF), and a User Plane Function (UPF), and
wherein the first network function is a network function configured to provide a service related to collection and exposure of energy-related information comprising the energy information related to the UE.

9. An apparatus configured to implement a first network function for energy-related information operating in a wireless communication system, the apparatus comprising:
a memory; and
a processor operably connected to the memory,
wherein the processor is configured to perform operations comprising:
receiving energy-related information from a User Plane Function (UPF), a Session Management Function (SMF), and an Operation, Administration, and Maintenance (OAM),
wherein the first network function has a direct or indirect interface with a Network Exposure Function (NEF), a Policy Control Function (PCF), a Unified Data Management (UDM), an Access and Mobility Management Function (AMF), the SMF, and the UPF; and
providing the energy-related information to a second network function,
wherein the first network function is configured to provide a service related to collection and exposure of the energy-related information.

10. The apparatus of claim 9, wherein the first network function comprises an Energy Information Repository Function (EIRF), and
wherein the second network function comprises an Application Function (AF).

11. The apparatus of claim 9, wherein the first network function is configured to receive energy consumption-related information per Network Function (NF) or per Single Network Slice Selection Assistance Information (S-NSSAI) from the OAM.

12. The apparatus of claim 9, wherein the first network function is configured to:
receive data volume information from the UPF; and
receive Protocol Data Unit (PDU) session-related information from the SMF.

13. The apparatus of claim 9, wherein the energy-related information comprises energy information provided by the network to an Application Function (AF).

14. The apparatus of claim 9,
wherein the first network function is configured to perform the energy-related information on a Network Function (NF) basis, a network slice basis, or a service basis.

15. A User Equipment (UE) configured to operate in a wireless communication system, the UE comprising:
a memory; and
a processor operably connected to the memory,
wherein the processor is configured to perform operations comprising:
providing, by the UE having an interface with an Access and Mobility Management Function (AMF), energy information related to the UE to a first network function; and
performing communication with a network operated based on information provided by the first network function,
wherein the first network function has a direct or indirect interface with a Network Exposure Function (NEF), a Policy Control Function (PCF), a Unified Data Management (UDM), the AMF, a Session Management Function (SMF), and a User Plane Function (UPF), and
wherein the first network function is a network function configured to provide a service related to collection and exposure of energy-related information comprising the energy information related to the UE.
